(19) United States
(12) Patent Application Publication
(10) Pub. No.: US 2024/0269595 A1
(43) Pub. Date: Aug. 15, 2024

(54) FILTER ELEMENT FOR FILTER SYSTEM AND FILTER SYSTEM COMPRISING FILTER HOUSING AND REPLACEABLE FILTER ELEMENT

(71) Applicant: MANN+HUMMEL GmbH, Ludwigsburg (DE)

(72) Inventors: Daniel SCHMID, Sachsenheim (DE); Kevin KOHN, Grossbottwar (DE)

(21) Appl. No.: 18/648,682

(22) Filed: Apr. 29, 2024

Related U.S. Application Data
(63) Continuation of application No. PCT/EP2022/075361, filed on Sep. 13, 2022.

(30) Foreign Application Priority Data
Nov. 4, 2021 (DE) 102021128686.7

(51) Int. Cl. B01D 46/42; B01D 46/00; B01D 46/52

(52) U.S. Cl. CPC B01D 46/4236; B01D 46/0002; B01D 46/521; B01D 2265/025

(57) ABSTRACT

A filter element has a holder arrangement with a filter bellows and a partition element arranged at different regions of the holder arrangement. The partition element extends between first and second chambers of a resonator structure when installed in a filter system and has a passage acoustically coupling the two chambers. Such a filter element is exchangeably arranged in the filter housing of the filter system which has a main inlet, a main outlet, and an auxiliary connection outlet. The filter bellows is arranged in flow direction between the main inlet and the two outlets. The partition element is arranged between the two chambers of the resonator structure for noise damping of the auxiliary connection outlet. Its passage acoustically couples the two chambers. The partition element projects into an auxiliary connection resonator region of the filter housing and has end regions contacting walls delimiting the auxiliary connection resonator region.

### CROSS-REFERENCE TO RELATED APPLICATIONS

This application is a continuation application of international application No. PCT/EP2022/075361 having an international filing date of Sep. 13, 2022, and designating the United States, the international application claiming a priority date of Nov. 4, 2021, based on prior filed German patent application No. 10 2021 128 686.7, the entire contents of the aforesaid international application and the aforesaid German patent application being incorporated herein by reference.

### BACKGROUND OF THE INVENTION

The invention concerns a filter element for a filter system with a holder arrangement which comprises a filter bellows at one region and a partition element at another region, as well as a filter system with a filter housing, such an exchangeable filter element, and with a resonator structure for noise damping.

CN 207 315 552 U discloses an air filter which comprises a top housing part, a filter element, a bottom housing part, and a sound absorber. The top housing part comprises an upper partition, the bottom housing part comprises a lower partition. The upper partition is positioned opposite the lower partition. The upper partition and the lower partition are adapted relative to each other. The cavity which is formed by the top housing part and the bottom housing part is divided into a sound absorber cavity and a filter cavity; the bottom housing part is provided with an air inlet which is in communication with the sound absorber cavity and the top housing part is provided with an air outlet which is in communication with the filter cavity. The filter element is located between the top housing part and the bottom housing part. A through hole is arranged in the lower partition. The sound absorber comprises a curved surface structure and a plurality of sound absorber holes. The bottom housing part comprises ribs which interact with the sound absorber in order to form a sound absorbing inner cavity, wherein the inner cavity of the sound absorber is in communication with the air inlet.

A further air filter of the aforementioned kind is disclosed in JP 2002-61 543 A.

### SUMMARY OF THE INVENTION

It is an object of the invention to provide a filter element for a filter system with a resonator structure for noise damping which can be produced inexpensively.

A further object is providing a filter system with an inlet, two outlets, and such a filter element and a resonator structure for noise damping, which can be produced in an inexpensive manner.

The aforementioned object is addressed according to an aspect of the invention by a filter element for a filter system, comprising a holder arrangement which comprises a filter bellows at one region and a partition element at another region.

A further object is solved by a filter system with a filter housing, an exchangeable filter element, a main inlet, a main outlet, an auxiliary connection outlet, and a resonator structure for noise damping of the auxiliary connection outlet. The filter bellows of the exchangeable filter element is arranged in flow direction between the main inlet and the two outlets. The partition element of the filter element projects into an auxiliary connection resonator region in the filter housing. End regions of the partition element each contact at least one wall delimiting the auxiliary connection resonator region.

According to an aspect of the invention, a filter element for a filter system is proposed, with a holder arrangement which comprises a filter bellows at one region and a partition element at another region. In an embodiment of use of the filter element, the partition element is arranged between two sealed chambers of a resonator structure, for example, a resonator structure for noise damping of an auxiliary connection outlet. The partition element comprises at least one passage through which the chambers are acoustically coupled with each other in an embodiment of use.

In an advantageous manner, the partition element forms the partition between the two sealed chambers of the resonator structure. Two volumes are produced due to the two chambers. The volumes correspond to a fluid column, for example, an air column. With such an arrangement, in an advantageous manner a so-called auxiliary connection resonator can be produced which comprises the two volumes which are acoustically coupled through the at least one passage in the partition element between the two volumes. The partition element can comprise, for example, a plurality of slots through which the two volumes are acoustically coupled with each other.

The holder arrangement can have an arbitrary shape adapted to the installation space of the corresponding filter housing. In this context, the holder arrangement or the regions of the holder arrangement can be arranged in a common plane. As an alternative, the regions of the holder arrangement can be arranged in different planes. In case of the arrangement in a common plane, the latter can be oriented perpendicular to a flow direction of the fluid to be filtered. In addition, the regions of the holder arrangement and the holder arrangement can have an arbitrary cross section. The cross sections can be circular, rectangular, triangular, polygonal, oval or the like. In addition, the regions of the holder arrangement which comprise the filter bellows or the partition element can comprise different cross sections.

The filter bellows and the partition element can project at the same angle away from the respective region of the holder arrangement. Different angles are also possible depending on the shape of a corresponding filter housing. Furthermore, the orientation of the filter bellows and of the partition element at the holder arrangement can be adapted to an installation space.

The filter bellows can comprise an arbitrary cross section. The cross section of the filter bellows can be circular, rectangular, triangular, polygonal, oval or the like and can be adapted beneficially to an existing installation space. In addition, the cross section can change along an axis. The filter bellows can comprise a folded filter medium or wound layers of filter medium. A combination of folded and wound filter media is possible. The filter bellows projects in an embodiment of use into a raw fluid region of the filter housing.

The partition element can also comprise an arbitrary shape adapted to the corresponding filter housing. For example, end regions of the partition element each contact at least one wall delimiting an auxiliary connection resonator region in an embodiment of use. The passages can comprise a shape and arrangement at the partition element adapted to the acoustic properties. Since the partition element contacts at least one wall delimiting an auxiliary connection resonator region, the fluid can only flow through the at least one passage from the first chamber into the second chamber. A flow of the fluid through gaps between the partition element and the corresponding wall can be prevented. In addition, a seal element can be arranged between end regions of the partition element and the corresponding wall.

A resonator formed with the partition element can be realized in a very limited installation space and can be produced inexpensively.

Since the partition element which separates the two chambers of the auxiliary connection resonator in the interior of the filter housing is a fixed component of the filter element, the partition element can be exchanged with every filter element exchange.

In addition, in the state of use of the filter element, filtering of the fluid and noise damping of an auxiliary connection outlet is possible only when the filter element and the filter housing are adapted relative to each other. In this way, it can be ensured that only suitable filter elements can be installed in the corresponding filter housing, whereby the functionality of a corresponding filter system is improved and compliance with a quality standard can be facilitated.

According to a beneficial embodiment of the filter element, the partition element can be arranged at a filter element-associated resonator partition and can project away from the resonator partition. The region of the holder arrangement at which the partition element is arranged can be configured as a frame in this context. The resonator partition can contact the frame or can be fastened to the frame and can span a free space between frame elements of the frame. As an alternative, the resonator partition can be part of the holder arrangement. In an embodiment of use, the resonator partition can form a wall delimiting an auxiliary connection resonator region. In an embodiment of use, the partition element projects in this context into the auxiliary connection resonator region of the filter housing, whereby the two chambers are formed. Due to this construction, it can be ensured that the partition element in the auxiliary connection resonator region is arranged at the correct position. For example, the partition element can project from above into the auxiliary connection resonator region and the resonator partition can form a ceiling of the auxiliary connection resonator region which covers both chambers. In this context, the resonator partition comprises dimensions which correspond to the cross sections of the two chambers in the region which covers the resonator partition, whereby both chambers are delimited by the resonator partition and an undesirable escape of the fluid from the chambers is made difficult. Alternatively, the resonator partition can delimit only one chamber or only partially delimit it and a further wall element covers the region which is exposed by the resonator partition. In addition, a volume ratio of the two chambers can be predetermined by the position of the partition element at the resonator partition.

According to a beneficial embodiment of the filter element, the partition element can comprise a comb-like structure with a plurality of passages, for example, the passages can comprise in this context dimensions which are adapted to at least one predetermined frequency of the resonator structure. In this context, the passages can be arranged at an end region of the partition element facing away from the resonator partition. For example, the passages can be arranged at a lower end region. Due to the comb-like structure, a beneficial manufacture of the partition element can be realized. Furthermore, by means of the passages a beneficial acoustic coupling of the two volumes available for the resonator structure can be achieved. The noise damping can thus be effectively improved.

According to a beneficial embodiment of the filter system, the resonator partition can have an opening which forms an inlet to a first chamber in an embodiment of use. Through the opening, filtered fluid and disturbing noises can flow into the first chamber. Due to an interaction by means of fluid columns in the corresponding passages and with the fluid column in the second chamber, the disturbing noises can be dampened and reduced in this way.

According to a beneficial embodiment of the filter element, the partition element can be arranged spaced apart from the filter bellows. In this context, the contour of the partition element can be arranged outside of the filter bellows and in this way designed independent of the shape of the filter bellows or independent of a cutout in the filter bellows. In this way, a designer is independent of manufacturing conditions of the filter bellows when designing the partition element and also when designing the resonator structure.

According to a beneficial embodiment of the filter element, the holder arrangement can comprise a circumferentially extending frame which surrounds the filter bellows and the resonator partition and which comprises a seal element. In an embodiment of use, the frame can be reliably sealed in relation to the filter housing. In this way, it can be prevented that a fluid can pass through between the frame and a corresponding housing wall of the filter housing. In this way, it can be prevented that the fluid passes from the raw fluid region of the filter housing into the clean fluid region of the filter housing without flowing through the filter element. In addition, it can be prevented in this way that the fluid can escape from the filter housing. The seal element which seals the region between the frame of the filter element and the filter housing can comprise a suitable seal material, for example, polyurethane (PUR), which is molded onto the frame or of which the frame is formed. In this manner, the sealing action can be achieved simply and reliably and no additional manufacturing steps are required. As an alternative, also separate tied-in or fitted seal elements of suitable material can be employed.

According to a further aspect of the invention, a filter system with a filter housing, an exchangeable filter element, a main inlet, a main outlet, an auxiliary connection outlet, and a resonator structure for noise damping of the auxiliary connection outlet is proposed. The filter bellows of the exchangeable filter element is arranged in flow direction between the main inlet and the two outlets. The partition element of the filter element projects into an auxiliary connection resonator region in the filter housing, wherein end regions of the partition element each contact at least one wall delimiting the auxiliary connection resonator region.

The filter element comprises a holder arrangement which comprises the filter bellows at one region and the partition element at another region. In an embodiment of use of the filter element, the partition element is arranged between two sealed chambers of the resonator structure. The partition element comprises at least one passage through which the two chambers in an embodiment of use are acoustically coupled with each other. Because the end regions of the partition element each contact at least one wall delimiting the auxiliary connection resonator region, the fluid can interact only through the passages of the partition element with the fluid column in the second chamber. Additionally, a seal element can be arranged between the end regions of the partition element and the respective wall. The auxiliary connection resonator region is closed in an embodiment of use, the fluid can only flow through corresponding inlet openings into the auxiliary connection resonator region and flow out of the auxiliary connection resonator region through corresponding outlet openings.

Due to the structure of the filter element, the chambers for an auxiliary connection resonator for the auxiliary connection outlet can be formed upon insertion of the filter element. In this context, the partition element divides the closed auxiliary connection resonator region into two chambers.

The auxiliary connection outlet can be used, for example, for auxiliary consumers such as compressors. This can be applied, for example, in a brake system of a truck. In this context, filtered fluid can flow through a first chamber and interact with a fluid or with a volume in the second chamber through the at least one passage in order to dampen disturbing noises.

The partition element which is arranged between the two chambers of the auxiliary connection resonator in the interior of the filter housing can be simply exchanged with every filter element exchange.

Advantageously, the resonator structure comprises for noise damping two parts, a filter element-associated partition element and at least one housing-associated wall which encloses the auxiliary connection resonator region. With such an arrangement, a so-called auxiliary connection resonator can be realized in an advantageous manner which comprises two volumes which are coupled through passages, for example, slots, in the partition element between the two volumes.

Such a resonator can be realized in a very limited installation space and can be produced inexpensively.

According to a beneficial embodiment of the filter system, the auxiliary connection resonator region with the partition element and the at least one wall delimiting the auxiliary connection resonator region can form two outwardly closed chambers which are acoustically coupled with each other, for example, wherein one of the walls delimiting the auxiliary connection resonator region is the filter element-associated resonator partition. In this context, walls can be formed by a tub-shaped filter housing part or by a tub-shaped region of the filter housing, wherein the region enclosed by the walls can be covered by the filter element-associated resonator partition. The partition element can have a contour which is adapted to the tub shape of the filter housing part or to the tub shape of the region of the filter housing. In this context, a bottom region of the partition element can contact a bottom or a ceiling of the filter housing or of the filter housing part. Side regions of the partition element can contact sidewalls. Other shapes of the partition element and of the filter housing in the auxiliary connection resonator region are also possible.

According to a beneficial embodiment of the filter system, an opening of a filter element-associated resonator partition can be fluidically coupled with the first chamber and form an auxiliary connection inlet. In this context, the first chamber can be flowed through by the filtered fluid. In this way, a beneficial connection between a clean fluid region in the interior space of the filter housing to a sufficiently large volume for noise damping can be produced. In addition, the first chamber can act as a passage between the clean fluid region and the auxiliary connection outlet.

According to a beneficial embodiment of the filter system, the filter housing can comprise an opening which is fluidically coupled with the first chamber and which forms the auxiliary connection outlet. Through the auxiliary connection outlet, the filtered fluid can be guided to the auxiliary consumer. In addition, the filter bellows can filter the fluid for a main consumer as well as for the auxiliary consumer.

According to a beneficial embodiment of the filter system, the auxiliary connection resonator region can comprise guide elements which guide the partition element. In addition, the guide elements can fix the partition element in a predetermined position. Due to the guide elements which are embodied, for example, as a groove, the insertion of the filter element into the filter housing and/or positioning of the filter element and/or of the filter bellows and/or of the partition element can be facilitated in an advantageous manner.

According to a beneficial embodiment of the filter system, the filter housing can be of a two-part configuration wherein a bottom element comprises the auxiliary connection resonator region. In this context, the bottom element can form a major portion of the walls enclosing the auxiliary connection resonator region. Due to the two-part configuration, the insertion and removal of the filter element and cleaning of the filter housing can be facilitated.

According to a beneficial embodiment of the filter system, the bottom element can comprise the inlet and the auxiliary connection outlet. A cover element can comprise the main outlet. In this context, a fluid flows from the main inlet through the raw fluid region and through the filter bellows, which is projecting into the raw fluid region, into a clean fluid region. From here, the fluid can flow through the main outlet out of the filter housing. The fluid can flow also through the auxiliary connection inlet into the first chamber of the resonator structure and from there through the auxiliary connection outlet out of the housing. The purified fluid can be used, for example, in a further system which requires purified fluid, for example, air, for example, in a brake system for commercial vehicles or the like. Furthermore, an interaction of the fluid in the first chamber with the second chamber can reduce disturbing noises in the housing or disturbing noises at the auxiliary connection outlet.

Sealing of the resonator structures and of the housing parts can be realized by a suitable seal material, for example, polyurethane (PUR), which, for example, are molded onto a frame element of the holder arrangement or to the housing. Alternatively, the seal element can also be a separate component which is tied in or fitted to the housing and/or to the holder arrangement. In this way, the auxiliary connection resonator region or the chambers of the auxiliary connection resonator region and an interior space of the housing can be reliably sealed upon intended assembly.

### BRIEF DESCRIPTION OF THE DRAWINGS

Further advantages result from the following drawing description. In the drawings, embodiments of the invention are illustrated. The drawings, the description, and the claims contain numerous features in combination. A person of skill in the art will consider the features expediently also individually and combine them to expedient further combinations.

FIG. 1 shows an isometric view of a filter element according to an embodiment of the invention in a view from below.

FIG. 2 shows an isometric view of a filter element of FIG. 1 in a view from above.

FIG. 3 shows an exploded view of a filter system according to an embodiment of the invention with a filter element from FIGS. 1 and 2.

FIG. 4 shows an isometric view from above of a bottom element of the filter system of FIG. 3.

FIG. 5 shows an isometric view from below of a cover element of the filter system of FIG. 3.

FIG. 6 shows a partially sectioned view of the filter system of FIG. 3 in an embodiment of use.

### DETAILED DESCRIPTION

In the Figures, same or same-type components are identified with same reference characters. The Figures show only examples and are not to be understood as limiting.

Directional terminology used in the following with terms such as “left”, “right”, “top”, “bottom”, “in front of”, “behind”, “after”, and the like serve only for better understanding of the Figures and do not represent in any case a limitation of the generality. The illustrated components and elements, their configuration and use can vary in the context of considerations of a person of skill in the art and be adapted to the respective applications.

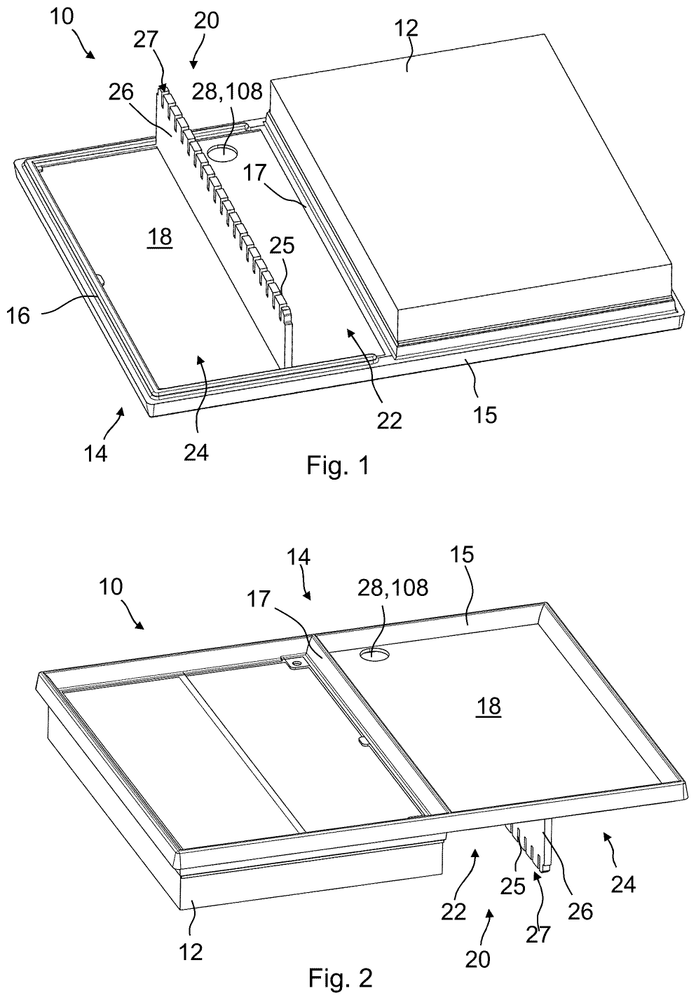

FIGS. 1 and 2 show an isometric view of a filter element 10 according to an embodiment of the invention as a view from below (FIG. 1) and from above (FIG. 2), respectively.

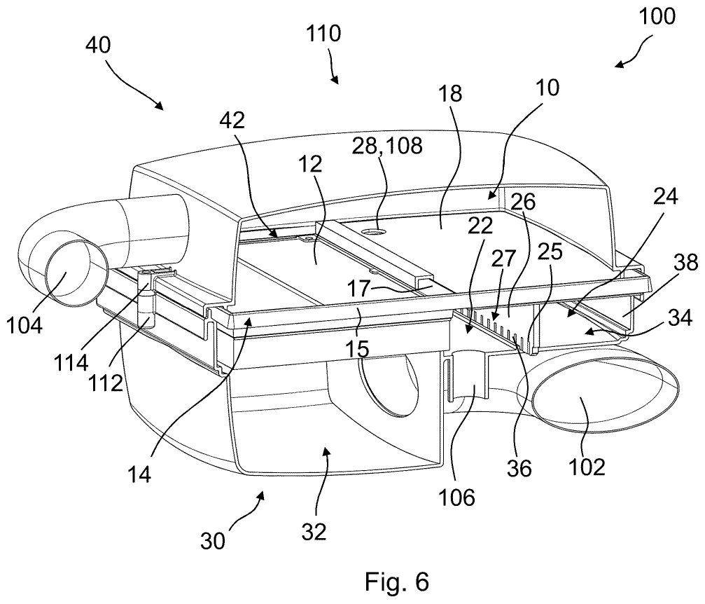

The filter element 10 comprises a holder arrangement 14 which comprises a filter bellows 12 at one region and a partition element 26 at another region. In an embodiment of use of the filter element 10 (FIG. 6), the partition element 26 is arranged between two sealed chambers 22, 24 of a resonator structure 20. For example, the resonator structure 20 can be configured for noise damping of an auxiliary connection outlet 106. The partition element 26 comprises at least one passage 25 through which the two chambers 22, 24 are acoustically coupled with each other in an embodiment of use.

As can be further seen in FIGS. 1 and 2, the partition element 26 in the illustrated embodiment is arranged at a filter element-associated resonator partition 18 and projects away from the resonator partition 18. Furthermore, the filter element 10 in the illustrated embodiment comprises a holder arrangement 14 which comprises a circumferentially extending frame 15 which surrounds the filter bellows 12 and the resonator partition 18 on three sides, respectively, and which comprises a seal element 16. In the illustrated embodiment, the seal element 16 is arranged only in the region of the frame 15 which extends around the resonator partition 18. In an alternative embodiment, the seal element 16 or a further seal element can extend in the region about the filter bellows 12. In the illustrated embodiment, the resonator partition 18 and the filter bellows 12 are connected to the frame 15 at a bottom side of the frame 15. Surfaces of the frame elements extend perpendicularly to the top side and to the bottom side of the filter bellows 12 and perpendicularly to the top side and to the bottom side of the resonator partition 18. Narrow sides of the frame elements each extend parallel to top sides and bottom sides of the filter bellows 12 and of the resonator partition 18. In addition, the filter bellows 12 and the resonator partition 18 comprises a rectangular cross section. Furthermore, a stay 17 extends in the frame 15 and divides the region enclosed by the frame 15 into two partial regions which correspond to the regions for the filter bellows 12 and the resonator partition 18. Furthermore, the dimensions of the partial regions in the illustrated embodiment are designed such that the partial region with the filter bellows 12 is adapted to a cross section of a raw fluid region 32 of the filter housing 110 and the partial region with the resonator partition 18 or with the partition element 26 is adjusted to a cross section of the auxiliary connection resonator region 34. In this way, in an embodiment of use, the raw fluid region 32 is covered by the filter bellows 12 and the auxiliary connection resonator region 34 by the resonator partition 18 in the illustrated embodiment.

In an embodiment, not illustrated, other shapes and dimensions of the holder arrangement 14 and/or of the frame 15 and/or of the stay 17 and/or of the partition element 26 and/or of the resonator partition 18 and/or of the filter bellows 12 are possible. For example, the cross sections can have other shapes than the illustrated rectangular shapes.

As can be further seen in FIGS. 1 and 2, the partition element 26 in the illustrated embodiment comprises a comb-like structure 27 with a plurality of passages 25, slot-shaped in this example. The passages 25 comprise dimensions which are adapted to at least one predetermined frequency of the resonator structure 20. The passages 25 of the partition element 26 in the illustrated embodiment are arranged at an end region of the partition element 26 facing away from the resonator partition 18. The passages 25 are open downwardly and are closed only in an embodiment of use (FIG. 6) by a housing wall of the filter housing 110. In an alternative embodiment, not illustrated, the comb-like structure 27 of the partition element 26 can also be arranged at another end region. Furthermore, the passage 25 or the passages 25 can also be introduced into the partition element 26 at other suitable regions of the partition element 26. Furthermore, suitable structures other than the illustrated comb-like structures 27 are possible.

As can be further seen in FIGS. 1 and 2, the filter element-associated resonator partition 18 comprises an opening which forms an inlet to a first chamber 22 in an embodiment of use (FIG. 6). The opening comprises a round cross section but other suitable shapes, such as angular or oval shapes, are also possible.

As can be further seen in FIGS. 1 and 2, the partition element 26 is arranged spaced apart from the filter bellows 12. In this way, the partition element 26 or a resonator structure 20 comprising the partition element 26 can be designed independent of the filter bellows 12.

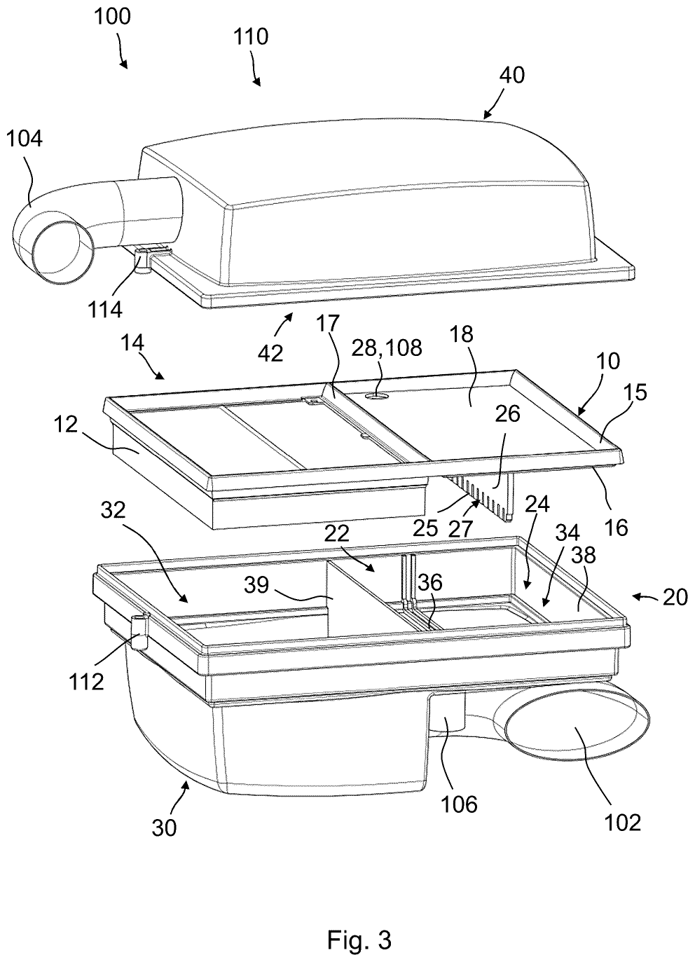

As can be further seen in FIGS. 3 to 6, the filter system 100 comprises a filter housing 110, an exchangeable filter element 10 illustrated in FIGS. 1 and 2, a main inlet 102, a main outlet 104, an auxiliary connection outlet 106, and a resonator structure 20 for noise damping of the auxiliary connection outlet 106. The filter bellows 12 of the exchangeable filter element 10 is arranged in flow direction between the main inlet 102 and the two outlets 104, 106. The partition element 26 of the filter element 10 projects into the auxiliary connection resonator region 34 in the filter housing 110. The end regions of the partition element 26 each contact at least one wall 38 delimiting the auxiliary connection resonator region 34.

As can be further seen in FIG. 6, the interior space enclosed by the filter housing 110 is divided into three regions: The raw fluid region 32 which adjoins the main inlet 102 and the filter bellows 12; a clean fluid region 42 which adjoins a side of the filter bellows 12 facing away from the raw fluid region 32 and which is thereby arranged in flow direction of the fluid downstream of the filter bellows 12; and the auxiliary connection resonator region 34 which adjoins the clean fluid region 42. The clean fluid region 42 is coupled with the main outlet 104, the auxiliary connection resonator region 34 is coupled with the auxiliary connection outlet 106. The regions are enclosed by walls such that the fluid can flow only through the filter bellows 12 from the raw fluid region 32 into the clean fluid region 42. Furthermore, there is no possibility for the fluid to flow directly from the raw fluid region 32 into the auxiliary connection resonator region 34. In the clean fluid region 42, the fluid can flow through the main outlet 104 out of the filter housing 110. In addition, the fluid can flow out of the clean fluid region 42 into the auxiliary connection resonator region 34 and from there through the auxiliary connection outlet 106 out of the filter housing 110.

As can be further seen in FIGS. 3 to 6, the filter housing 110 in the illustrated embodiment is of a two-part configuration. A bottom element 30 comprises the auxiliary connection resonator region 34. In this context, walls 38 of the bottom element 30 enclose the auxiliary connection resonator region 34 at least partially. The walls 38 are embodied as sidewalls and as bottom. The ceiling which covers the auxiliary connection resonator region 34 is formed by the resonator partition 18 of the filter element 10. The partition element 26 of the filter element 10 divides the auxiliary connection resonator region 34 into the two chambers 22, 24. In this way, by means of the partition element 26 and of the at least one wall 38 delimiting the auxiliary connection resonator region 34 and the resonator partition 18, two outwardly closed chambers 22, 24 which are acoustically coupled with each other are formed in the auxiliary connection resonator region 34. Through the passages 25 of the partition element 26, the two chambers 22, 24 are acoustically coupled with each other. The opening 28 of the filter element-associated resonator partition 18 is fluidically coupled with a first chamber 22 and fluidically couples the first chamber 22 with the clean fluid region 42. Furthermore, the opening 28 forms an auxiliary connection inlet 108. The auxiliary connection inlet 108 is arranged in this way in the clean fluid region 42 in the filter housing 110. The filter housing 110 comprises in addition an opening which is fluidically coupled with the first chamber 22 and which forms the auxiliary connection outlet 106. In this way, the filtered fluid can flow through the first chamber 22 of the resonator structure 20 in order to reach a further consumer. The further consumer can be a compressor in a brake system of a truck. Upon flow through the first chamber 22, disturbing noises can be dampened due to the interaction with the second chamber 24.

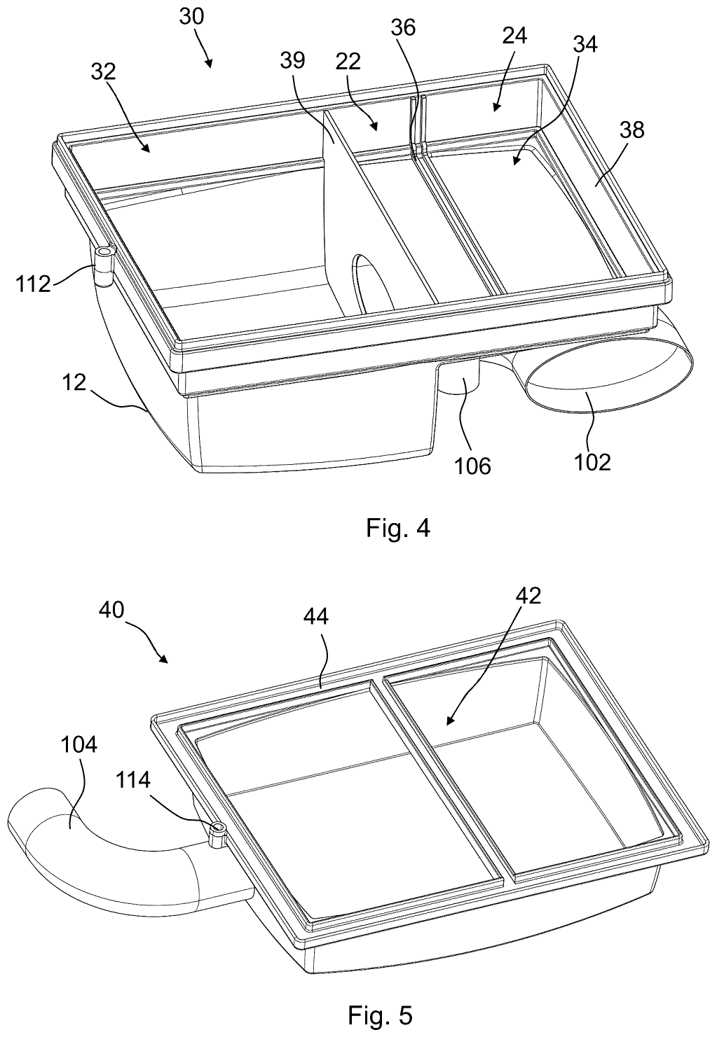

As can be further seen in FIGS. 3 and 4, the bottom element 30 comprises the main inlet 102 and the auxiliary connection outlet 106. Furthermore, the auxiliary connection resonator region 34 comprises guide elements 36 which guide the partition element 26. Guiding the partition element 26 can take place when the filter element 10 is exchanged and the filter element 10 is removed from the filter housing 110 for this purpose, or when a new filter element 10 is arranged in the filter housing 110. The guide elements 36 in the illustrated embodiment are configured as a groove and extend at oppositely positioned side wall regions and at the bottom. In an embodiment, not illustrated, a seal element is arranged in the guide element 36.

As can be further seen in FIGS. 3, 5, and 6, a cover element 40 of the filter housing 110 comprises the main outlet 104.

As can be further seen in FIG. 5, the cover element 40 comprises a receiving region 44 at an end region facing the bottom element 30. The receiving region 44 is embodied as a flute or as a groove and is arranged, circumferentially extending, at the cover element 40. The receiving region 44 is arranged so as to be positioned opposite to the frame 15 and to the stay 17 of the holder arrangement 14. In an embodiment of use, the receiving region 44 receives the frame 15 and the stay 17 of the holder arrangement 14 as well as the seal element 16 and a circumferentially extending rim of the bottom element 30. In this way, the regions in the interior space of the housing 110 can be reliably delimited. In addition, the housing parts 30, 40 comprise connection elements 114, 112 in order to be connected to each other in an embodiment of use.

As can be further seen in FIGS. 3 and 6, the resonator partition 18 contacts with a bottom side an intermediate wall 39 which separates with an upper region the raw fluid region 32 from the auxiliary connection resonator region 34 and forms with a lower region an outer wall. In addition, the resonator partition 18 and/or the frame elements surrounding the resonator partition 18 contact an inner edge of the bottom element 30.

In an alternative embodiment, not illustrated, the filter housing 110 can also be formed of only one filter housing part 30, 40 or of more than two filter housing parts 30, 40.

### REFERENCE CHARACTERS

10 filter element
12 filter bellows
14 holder arrangement
15 frame
16 seal element
17 stay
18 filter element-associated resonator partition
20 resonator structure
22 chamber
24 chamber
25 passage
26 partition element
27 comb-like structure
28 opening
30 bottom element/filter housing part
32 raw fluid region
34 auxiliary connection resonator region
36 guide element
38 bottom element-associated resonator partition/delimiting wall
39 intermediate wall
40 cover element/filter housing part
42 clean fluid region
44 receiving region
100 filter system
102 main inlet
104 main outlet
106 auxiliary connection outlet
108 auxiliary connection inlet
110 filter housing
112 connection element
114 connection element

What is claimed is:

1. A filter element for a filter system, the filter element comprising:
a holder arrangement comprising a filter bellows arranged at a first region of the holder arrangement and further comprising a partition element arranged at a second region of the holder arrangement;
wherein the partition element is configured to be arranged between a first chamber and a second chamber of a resonator structure of the filter system in an intended state of use of the filter element;
wherein the partition element comprises at least one passage, wherein the first and the second chambers are acoustically coupled with each other through the at least one passage in an embodiment of use.

2. The filter element according to claim 1, further comprising a resonator partition, wherein the partition element is arranged at the resonator partition and projects away from the resonator partition.

3. The filter element according to claim 2, wherein the resonator partition comprises an opening, wherein the opening is an inlet into the first chamber of the resonator structure in an embodiment of use.

4. The filter element according to claim 2, wherein the holder arrangement comprises a circumferentially extending frame surrounding the filter bellows and the resonator partition, wherein the circumferentially extending frame comprises a seal element.

5. The filter element according to claim 1, wherein the partition element is spaced apart from the filter bellows.

6. A filter system comprising:
a filter housing;
a filter element exchangeably arranged in the filter housing, wherein the filter element comprises a holder arrangement comprising a filter bellows arranged at a first region of the holder arrangement and further comprising a partition element arranged at a second region of the holder arrangement;
a main inlet;
two outlets, including a main outlet and an auxiliary connection outlet, wherein the filter bellows is arranged in a flow direction of a fluid to be filtered between the main inlet and the two outlets;
a resonator structure configured for noise damping of the auxiliary connection outlet, wherein the partition element is configured to be arranged between a first chamber of the resonator structure and a second chamber of the resonator structure in an intended state of use of the filter element in the filter housing;
wherein the partition element comprises at least one passage, wherein the first and the second chambers are acoustically coupled with each other through the at least one passage in an embodiment of use;
wherein the filter housing comprises an auxiliary connection resonator region;
wherein the partition element projects into the auxiliary connection resonator region of the filter housing;
wherein the partition element comprises end regions, wherein the end regions each contact one or more walls delimiting the auxiliary connection resonator region.

7. The filter system according to claim 6, wherein the partition element and the one or more walls delimiting the auxiliary connection resonator region form together the first chamber and the second chamber of the resonator structure, wherein the first chamber and the second chambers of the resonator structure are outwardly closed and are fluidically coupled with each other.

8. The filter system according to claim 7, wherein the one or more walls delimiting the auxiliary connection resonator region include a resonator partition of the filter element.

9. The filter system according to claim 8, wherein the resonator partition of the filter element comprises an opening, wherein the opening is fluidically coupled to the first chamber of the resonator structure and forms an auxiliary connection inlet.

10. The filter system according to claim 9, wherein the filter housing comprises an opening, wherein the opening of the filter housing is fluidically coupled with the first chamber of the resonator structure and forms the auxiliary connection outlet.

11. The filter system according to claim 6, wherein the auxiliary connection resonator region comprises guide elements configured to guide the partition element.

12. The filter system according to claim 6, wherein the filter housing is comprised of two parts.

13. The filter system according to claim 12, wherein the two parts of the filter housing include a bottom element and a cover element, wherein the bottom element comprises the auxiliary connection resonator region.

14. The filter system according to claim 13, wherein the bottom element comprises the main inlet and the auxiliary connection outlet and wherein the cover element comprises the main outlet.
